(19) United States
(12) Patent Application Publication
(10) Pub. No.: US 2016/0080804 A1
(43) Pub. Date: Mar. 17, 2016

(54) MONITORING MEDIA PLAYBACK

(71) Applicant: Comprobo Limited, Frensham, Surrey (GB)

(72) Inventor: James Dalton FIRTH, Farnham, Surrey (GB)

(73) Assignee: Comprobo Limited, Frensham, Surrey (GB)

(21) Appl. No.: 14/888,886

(22) PCT Filed: Apr. 25, 2014
(86) PCT No.: PCT/GB2014/051310

§ 371 Date: Nov. 3, 2015

(30) Foreign Application Priority Data
May 3, 2013 (GB) 1308143.5

(51) Int. Cl. H04N 21/442; H04N 21/43; H04N 21/242; H04N 21/658; H04N 21/24

(52) U.S. Cl. CPC H04N 21/44204; H04N 21/6582; H04N 21/44222; H04N 21/2407; H04N 21/242; H04N 21/4302; H04N 21/44218

(57) ABSTRACT

A method of monitoring media playback includes outputting media content from a server over a network to a client device, and receiving at the server from the client device, a plurality of beacon signals, each beacon signal having at least one pair of timing data items. A first data item in the pair represents a point in time in the media content and a second data item in the pair represents a time indicated by a real time clock of the client device at which time the part of media content corresponding to the point in time was being played by the client device. The at least one of processed or stored beacon signals are at the server so as to monitor the playback of the media content by the client device.

This invention relates to providing media content, in particular it relates to methods and apparatus for monitoring and/or controlling media playback in a system where a server is arranged to output media content over a network to a client device.

Typically such a system will make use of the internet with a browser running on the client device to playback the media content.

In many circumstances the media content will be audiovisual content, typically a video, with an accompanying soundtrack. However, other forms of media content which consist of a pre-ordered sequence of content may be delivered.

There are many different reasons why it can be desirable to be able to determine whether remotely supplied media content has been properly and completely played at a client device.

This might allow an organisation to determine that a person has sat through a remote learning lesson in the form of media content, or allow an organisation to be satisfied or evidence that staff or others have viewed a health and safety video, or to show that a set of terms and conditions has been properly reviewed, and so on.

Where media content is provided remotely from a server to a client device for consumption by a user, there are various different ways in which delivery may be incomplete or unsuccessful and also various different ways in which a user may attempt to “cheat” the system into believing that the content has been properly consumed, when in fact it has not.

It is also the case that it is desirable to allow playback to be carried out by a user on one of a wide variety of different client devices running different software, and yet still be able to determine whether the content has been completely and properly delivered.

The present invention is aimed at providing methods and apparatus for supplying media content, and also monitoring the playback of that content with these types of factors in mind.

According to a first aspect of the present invention there is provided a method of monitoring media playback in a system where a server is arranged under the control of software to output media content over a network to a client device, the method comprising the steps of: outputting media content from a server over a network to a client device, receiving at the server from the client device, a plurality of beacon signals, each beacon signal comprising at least one pair of timing data items, a first data item in the pair representing a point in time in the media content and a second data item in the pair representing a time indicated by a real time clock of the client device at which time the part of media content corresponding to said point in time was being played by the client device, and

at least one of processing and storing the beacon signals at the server so as to monitor the playback of the media content by the client device.

This can help to allow determination of whether media content is actually played rather failing to download, or being downloaded and ignored, or fast-forward or similar. It can allow a determination of whether playback of the media content at the client device has remained in synch with the real time clock at the client device.

Said point in time in the media content may be represented by a time code. A time code will typically indicate the amount of time since the media content started. Similarly said point in time in the media content may be represented by a value indicating the proportion of the media content which falls before that point of the content—such as a % complete value. This is still considered timing data in this specification and of course knowledge of the total length of the media content allows a time code to be deduced.

Preferably the media content is streamed media content. That is to say preferably the media content is delivered to the client device whilst the user is playing the media content.

Preferably the beacon signals are received spaced in time from one another. Preferably the beacon signals are received whilst the media content is being streamed to the client device.

The method may comprise the further step, at the server, of deciding in dependence on the received beacon signals whether a predetermined portion of the media content has been properly and completely played by the client device.

The predetermined portion may be all of the media content or some other portion, for example the portion up until the point in time indicated by the most recently received beacon signal, or a selected portion.

The deciding step may comprise the step of, at the server, comparing at least two pairs of received data items.

The deciding step may comprise a first interval comparison step, comprising:

using a first pair of data items and a second pair of data items,
determining as a content time interval, the time interval between the point in time in the media content indicated by the first pair of data items and the point in time in the media content indicated by the second pair of data items,
determining as a playback time interval, the time interval between the time indicated by a real time clock of the client device indicated by the first pair of data items and the time indicated by a real time clock of the client device indicated by the second pair of data items, and
comparing the content and playback time intervals.

The above interval comparison step may be used multiple times during playback of the media content.

Each beacon signal may further comprise a media playback control data item indicating of operation at least one playback control function at the client device.

The playback control function may comprise a play control, a pause control, a fast-forward control, a stop control and so on.

In this way the server can monitor whether and when a user has started, stopped, paused and so on playback of the media content.

The deciding step may comprise analysing received media playback control data items.

The method may comprise the further step of logging, at the server, of a time of receipt of each beacon signal at the server, with reference to a real time clock at the server.

The deciding step may comprise analysing the time of receipt of each beacon signal.

The deciding step may comprise correlating at least one of the timing data items in at least one beacon signal with the time of receipt of the respective beacon signal.

The deciding step may comprise a second interval comparison step, comprising:

using at least one timing data item of a first beacon signal and at least one timing data item of a second beacon signal,
using a time of receipt of the first and second beacon signals,
determining as a playback time interval, the time interval between the time indicated by a real time clock of the client device indicated by the first beacon signal and the time indicated by a real time clock of the client device indicated by the second beacon signal,
determining as a reception time interval, the time interval between the time of receipt of the first and second beacon signals and
comparing the playback and reception time intervals.

The first and second interval comparison steps may be used together so that the content time interval, the playback interval and reception time interval, are all compared.

The deciding step may comprise calculating a time averaged value for at least one of the types of intervals and using the time averaged value in comparison to at least one of the other intervals or a time averaged value thereof.

Using intervals and averaging helps to take into account latency in the system and aids in highlighting of any instances of the media content not playing properly. This might be due to system, eg network, glitches or be indicative of interference with the system.

The method may comprise the further step of measuring at the server the amount of media content data output to the client.

Each beacon signal may further comprise a buffer content data item indicating the amount of media content data buffered at the client device at the time of generation of the beacon signal.

The deciding step may comprise:

determining the amount of the media content played by the client device at the time of generation of a beacon signal in dependence on the first timing data item of the beacon signal which represents a point in time in the media content; and
comparing the measured amount of media content data output to the client to the sum of the determined amount of the media content played and the amount of media content data buffered at the client device as indicated by the buffer content data item in the beacon signal.

If the media content is being played properly and completely these compared amounts should be equal.

The method may comprise the step of determining a typical value for end-to-end network latency.

The method may comprise the step of determining a difference between the real time clock of the client device and a real time clock at the server based on at least one signal received at the server including a data item indicating the time of generation of the signal at the client device, the time of receipt of that signal and the typical value for end-to-end network latency.

Said at least one signal may comprise one of said beacon signals.

The deciding step may comprise:

determining whether the time at which a respective one of the beacon signals is received at the server is anomalous based on a comparison of:
i) the second timing data item of the respective beacon signal representing a time indicated by a real time clock of the client device,
ii) the time of receipt of the respective beacon signal at the server, and
iii) a determined difference between the real time clock of the client device and the real time clock at the server.

The step of determining whether the time at which a respective one of the beacon signals is received at the server is anomalous may be carried out at the time that each beacon signal is received.

That is to say this aspect of the deciding step may be carried out in real time.

The deciding step may comprise the step of monitoring the network quality of service associated with playback of the media content at the client device on the basis of at least one of: the content of the received beacon signals, the time of receipt of the received beacon signals, and the determined difference between the real time clock of the client device and a real time clock at the server.

This can help determine whether there were network issues such as to disrupt the proper and complete playback of the media content or indicate a concerted attempt to cheat the system.

The method may comprise the further step of receiving at the server at least one image comprising at least one of: a snapshot from a camera of the client device and a screen grab from the content playing back at the client device.

The server may also receive a time code and/or a time stamp associated with the at least one image corresponding to the timing of the snapshot and/or screen grab.

Preferably a snapshot and screen grab will both be received and preferably have been taken at substantially the same time, by the client device. Such images help indicate user presence and successful playback of the media content. If there were a missing playback component such as a video codec, the screen grab would fail or be blank.

Where based on the deciding step it has been determined that at least the predetermined portion of the media content has been properly and completed played at the client device, the method may comprise the step of creating a validation file including an indication that the predetermined portion of the media content has been properly and completed played at the client device.

The method may comprise receiving and storing at the server, identification data for verifying the presence of a particular user at the client device. Such identification data may be received at initiation of the outputting of the media content and/or at periodic intervals during the playback of the content.

The identification data may preferably comprise photographic or video data showing the presence of the user, but other data such as biometric data, password data, personal information data or so on might be used.

This can help show presence of a particular user. It can also give a further indication that playback has been successful i.e. at least some questions may require watching and/or listening to the content to promote the correct answer.

The method may comprise outputting to the client device, along with the media content, prompts for user response and causing stopping or pausing of playback at the client device in the absence of appropriate user response.

This can help show attention of a user.

The method may comprise outputting to the client device questions to test user understanding of the media content, receiving answers to the questions and at least one of storing the answers and making a determination of whether the media content has been understood based on the answers.

This can help show understanding of a user. It can also give a further indication that playback has been successful—ie at least some questions may be such as to require watching and/or listening to the content to provide the correct answer.

The validation file may include one of or a combination of: an indication that a particular user was present during playback, an indication that a user was giving attention during playback, an indication that a user understood the content.

According to a second aspect of the present invention there is provided a media playback server for outputting media content over a network to a client device and monitoring playback of the media content, the server being arranged under the control of software to:

output media content from the server over a network to a client device, receive from the client device, a plurality of beacon signals, each beacon signal comprising at least one pair of timing data items, a first data item in the pair representing a point in time in the media content and a second data item in the pair representing a time indicated by a real time clock of the client device at which time the part of media content corresponding to said point in time was being played by the client device, and
at least one of process and store the beacon signals at the server so as to monitor the playback of the media content by the client device.

All of the sub features described above in relation to the first aspect of the invention are equally applicable to the second aspect of invention. Corresponding sub features could be written in each case with necessary changes in wording from method to apparatus, however, they are not written here for the sake of brevity.

According to a third aspect of the present invention there is provided a method for monitoring media playback in system where a client device is arranged under the control of software to receive media content over a network from a server, the method comprising the steps of:

receiving media content from a server over a network at a client device, playing back the media content to a user, and
sending from the client device to the server, a plurality of beacon signals, each beacon signal comprising at least one pair of timing data items, a first data item in the pair representing a point in time in the media content and a second data item in the pair representing a time indicated by a real time clock of the client device at which time the part of media content corresponding to said point in time was being played by the client device, thus allowing monitoring by the server of playback of the media content at the client device.

Said point in time in the media content may be represented by a time code. A time code will typically indicate the amount of time since the media content started. Similarly said point in time in the media content may be represented by a value indicating the proportion of the media content which falls before that point of the content—such as a % complete value. This is still considered timing data in this specification and of course knowledge of the total length of the media content allows a time code to be deduced.

Preferably the media content is streamed media content. That is to say preferably the media content is delivered to the client device whilst the user is playing the media content.

Preferably the beacon signals are sent spaced in time from one another. Preferably the beacon signals are sent whilst the media content is being streamed to the client device.

Each beacon signal may further comprise a media playback control data item indicating of operation at least one playback control function at the client device.

The playback control function may comprise a play control, a pause control, a fast-forward control, a stop control and so on.

Each beacon signal may further comprise a buffer content data item indicating the amount of media content data buffered at the client device at the time of generation of the beacon signal.

The method may comprise obtaining and sending to the server, identification data for verifying the presence of a particular user at the client device. Such identification data may be obtained and sent at initiation of the receipt of the media content and/or at periodic intervals during the playback of the content.

The identification data may preferably comprise photographic or video data showing the presence of the user, but other data such as biometric data, password data, personal information data or so on might be used.

The method may comprise receiving at the client device, along with the media content, prompts for user response and stopping or pausing of playback at the client device in the absence of appropriate user response.

The method may comprise receiving at the client device questions to test user understanding of the media content, presenting the questions to the user, receiving answers to the questions and sending the answers to the server.

The method may comprise the client device being arranged to acquire at least one image comprising at least one of a snapshot from a camera of the client device and a screen grab from the content playing back at the client device.

The client device may also associate a time code and/or a time stamp with the at least one image corresponding to the timing of the snapshot and/or screen grab.

Preferably a snap shot and a screen grab will both be acquired and sent to the server and preferably have been taken at substantially the same time, by the client device.

The client device may be arranged to acquire a screen grab and/or snapshot upon receipt of an instruction from the server.

According to a fourth aspect of the present invention there is provided a client device for use in monitored playback of media content, the client device being arranged under the control of software to:

receive media content over a network from a server,
play back the media content to a user, and
send from the client device to the server, a plurality of beacon signals, each beacon signal comprising at least one pair of timing data items, a first data item in the pair representing a point in time in the media content and a second data item in the pair representing a time indicated by a real time clock of the client device at which time the part of media content corresponding to said point in time was being played by the client device, thus allowing monitoring by the server of playback of the media content at the client device.

All of the sub features described above in relation to the third aspect of the invention are equally applicable to the fourth aspect of invention. Corresponding sub features could be written in each case with necessary changes in wording from method to apparatus, however, they are not written here for the sake of brevity.

According to a fifth aspect of the present invention there is provided a method of monitoring media playback in system where a server is arranged under the control of software to output media content over a network to a client device which is arranged under the control of software to playback the media content, the method comprising the steps of:

outputting media content from a server over a network to a client device,
receiving media content from the server at the client device,
playing back the media content to a user at the client device, sending from the client device to the server, a plurality of beacon signals, each beacon signal comprising at least one pair of timing data items, a first data item in the pair representing a point in time in the media content and a second data item in the pair representing a time indicated by a real time clock of the client device at which time the part of media content corresponding to said point in time was being played by the client device,
receiving at the server from the client device, the plurality of beacon signals, and
at least one of processing and storing the beacon signals at the server so as to monitor the playback of the media content by the client device.

All of the sub features described above in relation to the first and third aspects of the invention are equally applicable to the fifth aspect of invention. The features are not re-written here for the sake of brevity.

According to a sixth aspect of the present invention there is provided a media playback system comprising a server and a client device, which are connected over a network,

the server being arranged under the control of software to output media content to the client device and monitor the playback of the media content by the client device which is arranged under the control of software to playback the media content, wherein
the client device comprises a real time clock and is arranged under the control of software to send to the server a plurality of beacon signals, each beacon signal comprising at least one pair of data items, a first data item in the pair representing a point in time in the media content and a second data item in the pair representing a time indicated by the client device real time clock at which the part of media content corresponding to said point in time was being played by the client device, and
the server is arranged under the control of software to receive and at least one of process and store the beacon signals so as to monitor the playback of the media content by the client device.

All of the sub features described above in relation to the fifth aspect of the invention are equally applicable to the sixth aspect of invention. Corresponding sub features could be written in each case with necessary changes in wording from method to apparatus, however, they are not written here for the sake of brevity.

In each case above, the media content in principle can be any sequenced series of audio, audiovisual, or visual data items. Thus the media content may, for example, comprise an audio track, a video with or without sound, or a preset sequence of photographs or presentation slides or similar with or without sound.

Preferably the media content is video content.

According to another aspect of the present invention there is provided a video playback system comprising a server connected to a client device over a network,

the server being arranged under the control of software to output a video stream to the client device and monitor the playback of the video stream by the client device, wherein
the client device comprises a real time clock and is arranged under the control of software to send to the server a plurality of beacon signals, each beacon signal comprising at least one pair of timing data items, a first data item in the pair representing a time code from the video stream and a second data item in the pair representing a time indicated by the client device real time clock at which the part of video stream corresponding to said time code was being played by the client device, and
the server is arranged under the control of software to at least one of process and store the beacon signals so as to monitor the playback of the video content by the client device.

According to a further aspect of the present invention there is provided a computer program comprising code portions which when loaded and run on a computer cause the computer to carry out a method as defined above or cause the computer to operate as a server or client device as defined above.

There may be a set of computer programs for a set of computers, at least one program being arranged to cause a respective computer to act as a client device as defined above and at least one program being arranged to cause a respective computer to act as a server as defined above.

According to another aspect of the present invention there is provided a computer program product comprising a machine readable data carrier on which is carried a computer program or set of computer programs as defined above.

The data carrier may comprise a physical media for example a DVD, CD, Hard Drive, flash memory stick or so on.

Embodiments of the present invention will now be described, by way of example only, with reference to the accompanying drawings, in which:

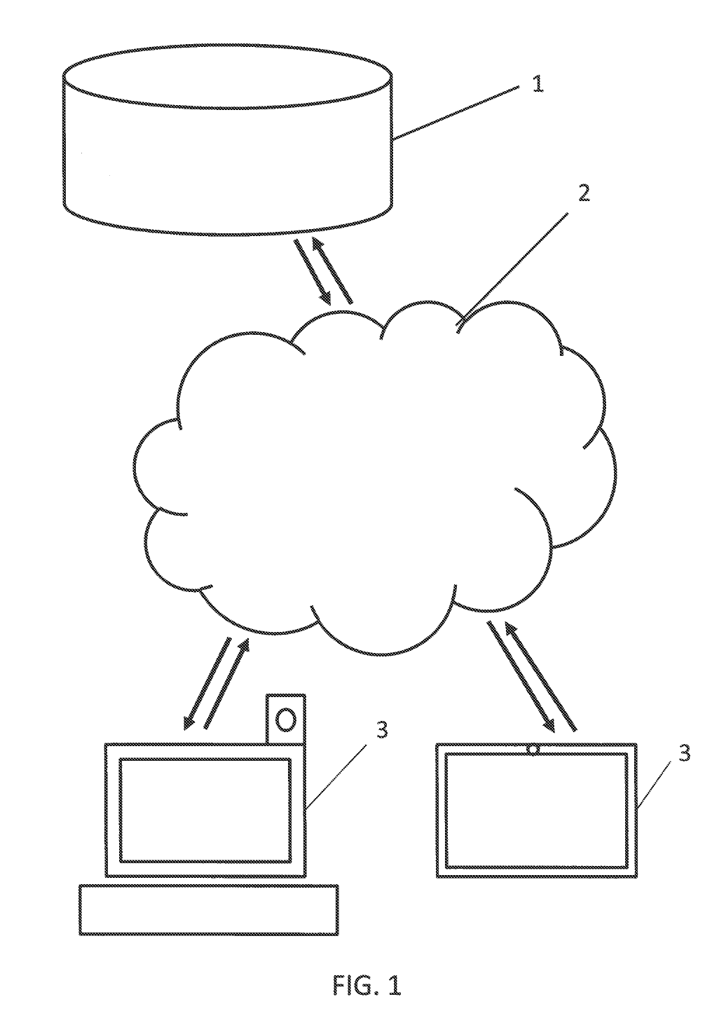

FIG. 1 schematically shows basic architecture for use in delivering media content for playback at a client device, and monitoring that playback;

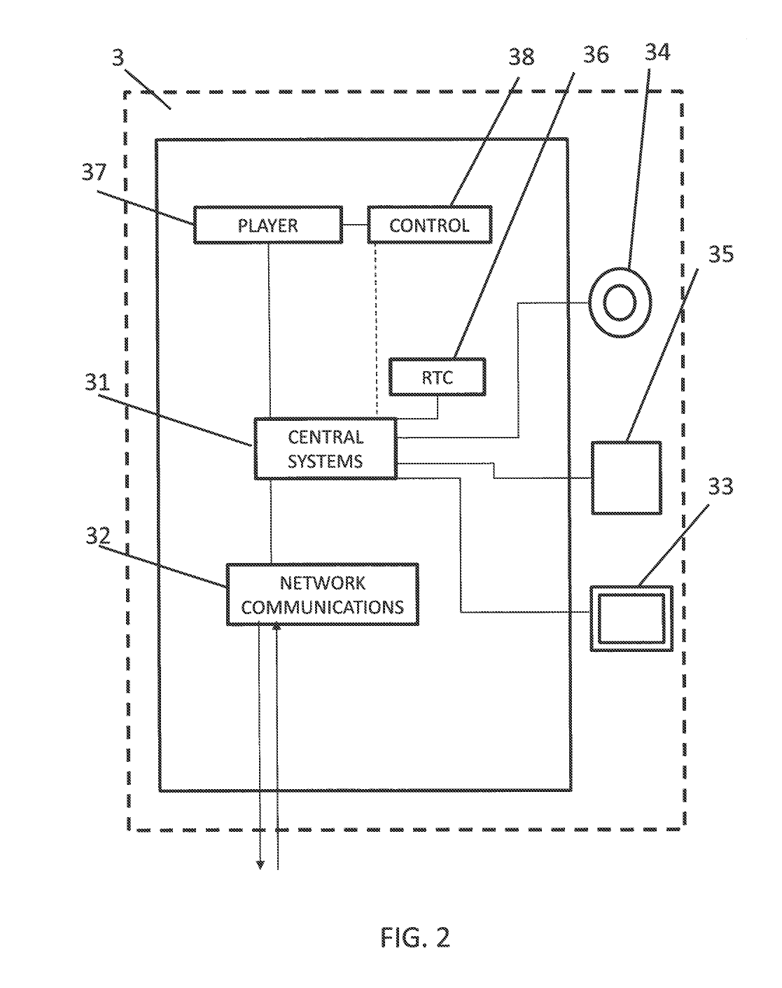

FIG. 2 schematically shows a client device for use in a method of delivering and monitoring playback of media content;

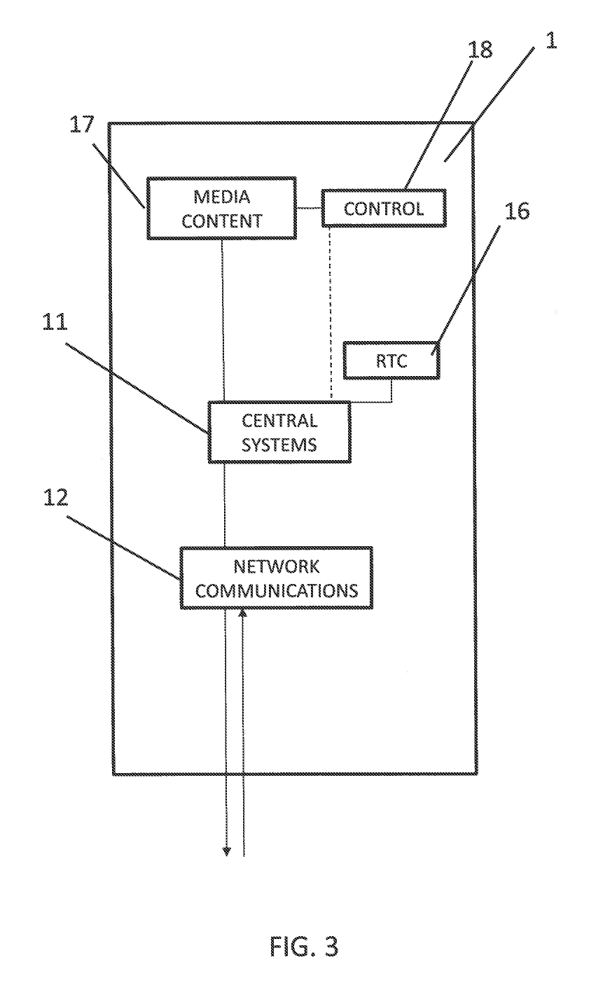

FIG. 3 schematically shows a server for use in a method of delivering and monitoring playback of media content;

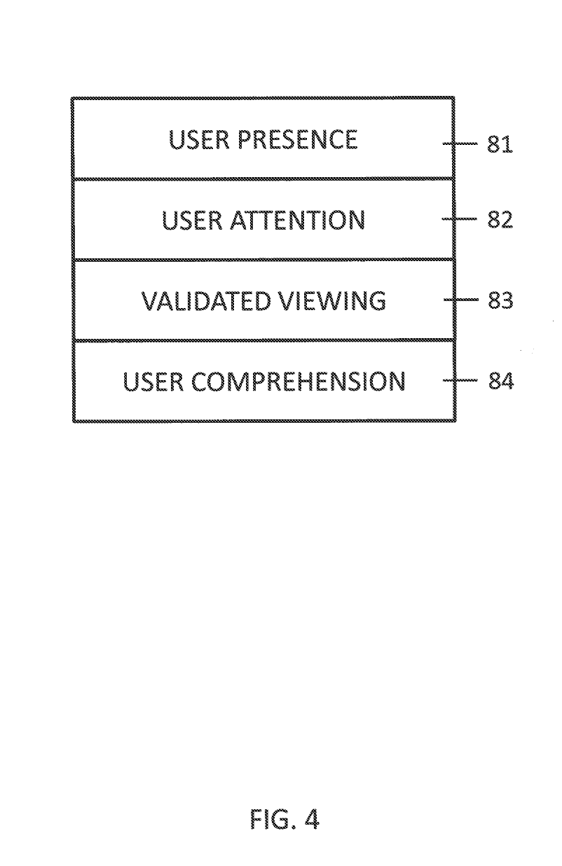

FIG. 4 shows, in highly schematic form, elements of a software program for controlling the delivery of and monitoring playback of media content;

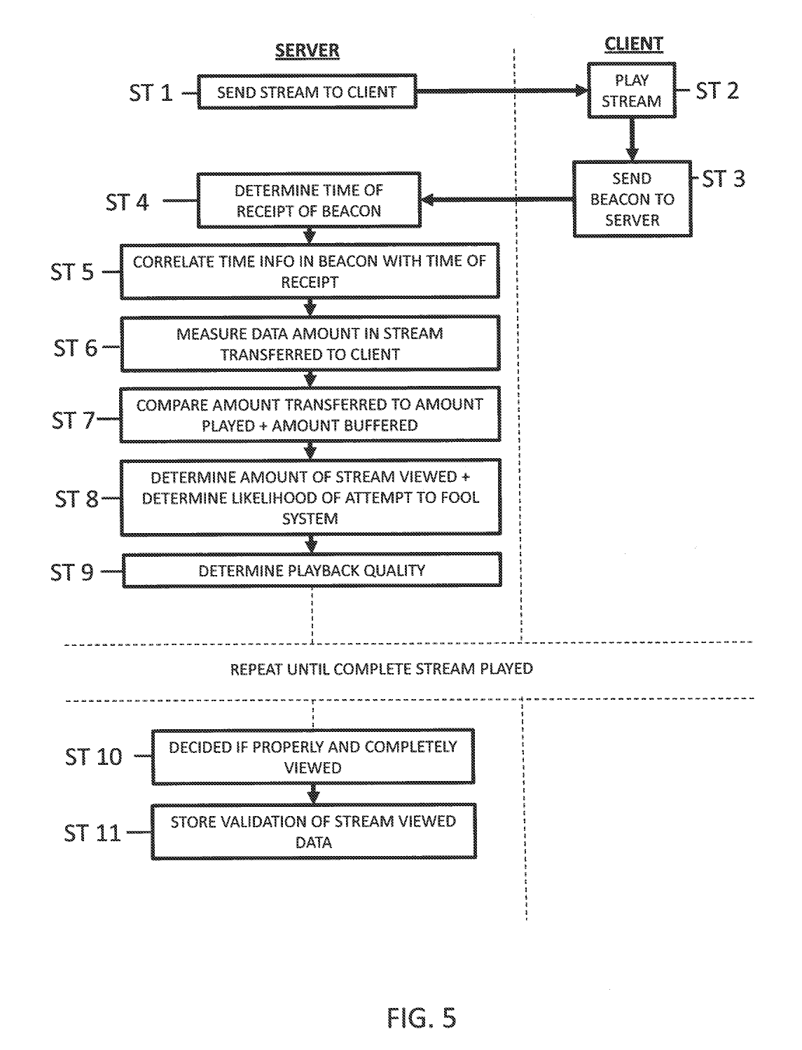

FIG. 5 is a flow chart schematically showing a process used for delivering media content from a server to a client and monitoring its playback;

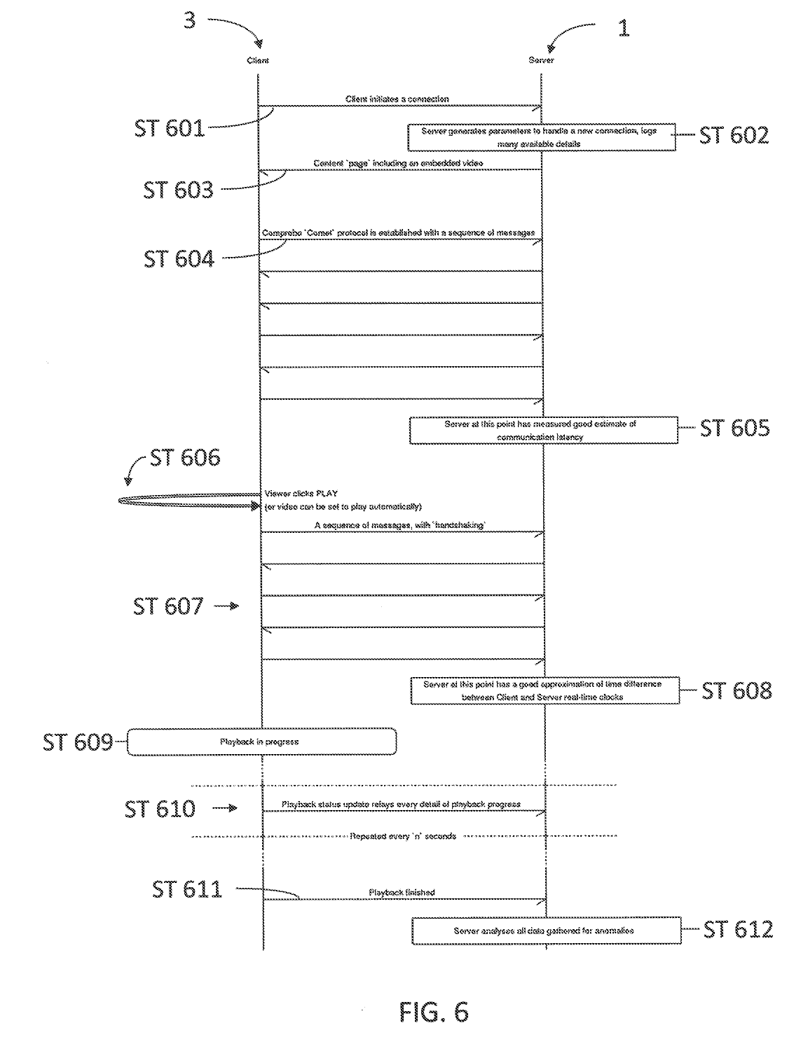

FIG. 6 shows an overview of more detailed interactions between a client and server in a specific implementation of the present techniques;

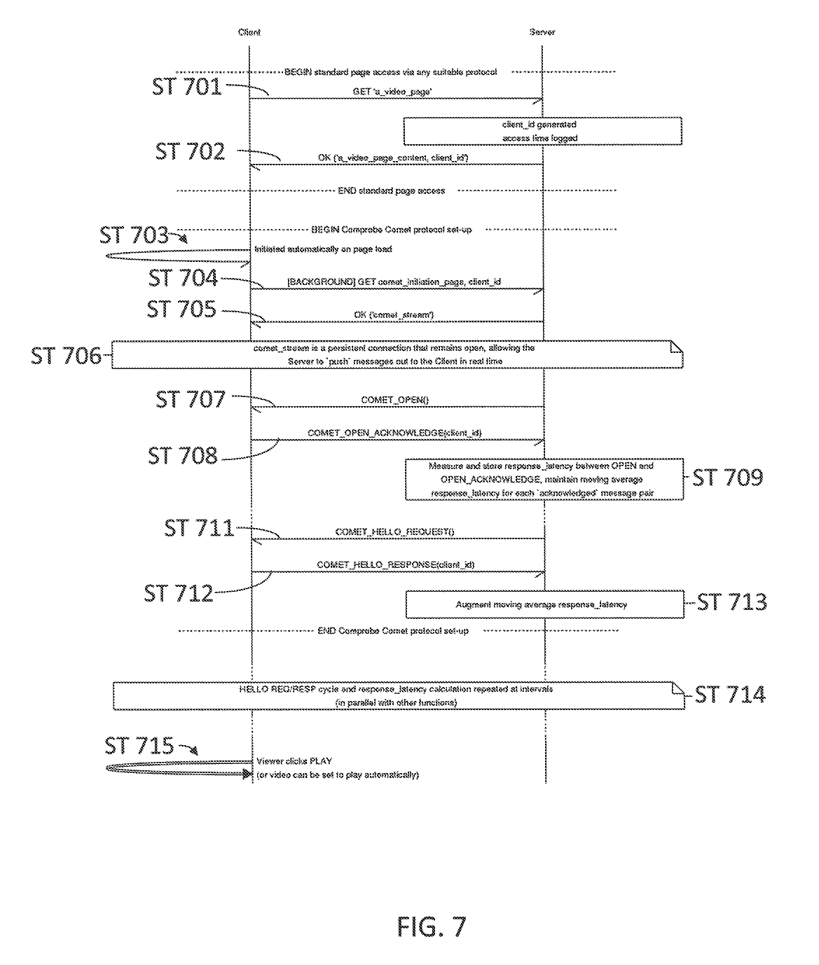

FIG. 7 shows in more detail specific interactions between the client and server during a server/client initiation process of the specific implementation of the current techniques shown in FIG. 6; and

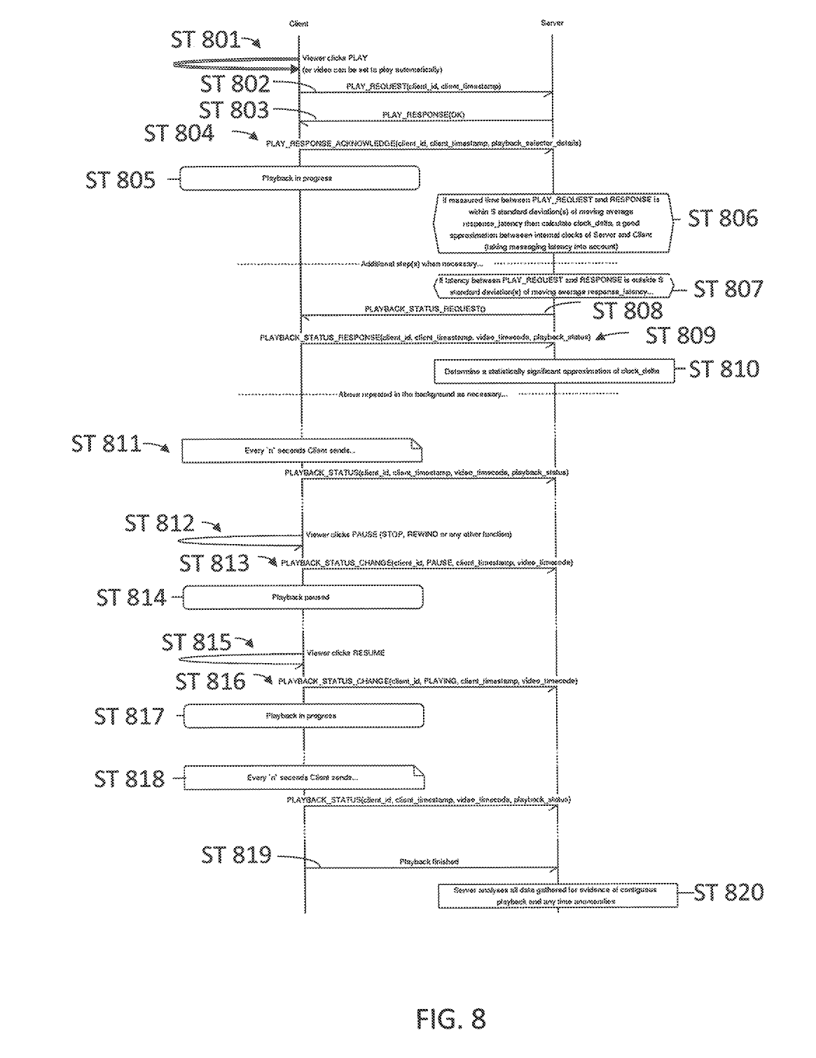

FIG. 8 shows in more detail specific interactions between a client and server during playback in the specific implementation of the current techniques shown in FIG. 6.

FIG. 1 schematically shows the basic architecture used in a system for providing media content to a client device over a network from a server. Typically there will be at least one server 1 which is arranged to output media content via a network 2 to a plurality of client devices 3. In practical terms there can be almost any number of client devices 3, but for the sake of simplicity only two client devices 3 are shown in FIG. 1. There may be a wide range of different types of client device 3. Each client device 3 needs to be able to receive the media content from the server via the network 2 and play this media content to a user.

FIG. 2 schematically shows a typical client device 3 in more detail. The basis of any client device 3 will be some kind of computer. This may be a smart phone, a tablet, a pc/laptop, or any other suitable device running appropriate software. Of course much of the software running on the device will be conventional, but it will also include elements which are specific to the current techniques.

Thus the client device 3 comprises central systems 31 made up of the main hardware and software elements of the client device 3 and arranged for running and controlling the overall behaviour of the device. Connected to the central systems 31 is a network communications module 32 for handling communications via the network 2, at least one output device 33, such as a screen and/or speaker, for delivering the media content to a user, and at least one input device 34,35 for accepting inputs from the user. In the present example, two input devices are illustrated. First a camera 34 which may, for example, be used to take video or photographic images of a user at the client device, and second a more conventional input device 35, such as a touch screen, keyboard or mouse or so on to allow user input. In other cases a microphone can be provided as an alternative or additional input device.

The client device also comprises a real-time clock 36 which may be implemented in hardware and/or software and, as is well understood, is used for indicating current time and generally also current date at the client device 3.

The client device 3 also includes a player 37 for playing the media content to be delivered to the client device 3 over the network 2. In general terms this player can be any suitable piece of software, hardware or any combination for playing the delivered media content. In practice the player will often comprise a browser (with an appropriate plug in) such as one of the widely available web browsers which is appropriate for use on the specific type of client device 3.

Alongside the player 37 is another module 38 which acts as a control module for controlling and assisting in monitoring playback of the media content by the player 37. The control module 38 may reside within the player module 37 and thus, for example, run within a browser, or may, in some implementations, be external to this. Thus the control module 38 may or may not be connected directly to the central systems 31 of the client device 3.

It is really the makeup and function of the control module 38 which is relevant to operation of the present invention. To put this another way, it is due to the presence of the control module 38 that the client device will embody the present invention.

FIG. 3 schematically shows the server 1 of FIG. 1 in more detail. Again the server will comprise central systems 11 including the main hardware and software elements of the server. Connected to this is a network communications module 12 for allowing communications via the network 2. The server also comprises a real time clock 16 implemented in hardware and/or software for again keeping a record of current time and generally also current date. The server also includes a media content module 17 for storing and outputting the media content via the network communications module 12 to the client device 3. Again, associated with the media content module 17 is a control module 18 which is arranged for controlling delivery of the media content and storing relevant data concerning its delivery. Thus the control module 18 in the server 1 is the element of the server 1 which is most relevant to the present techniques. Again the control module 18 may form part of the media content module 17 or be separate therefrom.

As alluded to above, due to the presence of the control module 18 in the server 1 and the control module 38 in the client 3, the present system is arranged to not only deliver media content on the server 1 to the client device 3, but also to control and monitor the delivery of that media content.

There can be various aspects to such control and monitoring.

In some senses the two control modules 18 and 38 can be considered together to provide the control and monitoring functionality. The scope of this control and monitoring functionality is illustrated in highly schematic form in FIG. 4. Thus in general terms the control modules 18 and 38 together can provide control and monitoring in respect of user presence 81, user attention 82, validated viewing 83, and user comprehension 84.

User presence 81 may be monitored by, for example, requiring the input of certain data via the input devices 34, 35 at the client device. There are many forms which this might take. For example, a password may be required, or biometric information input taken or detected, or photographs maybe taken of the user at random times, or video taken of the user during the whole session.

User attention 82 can be controlled and monitored by virtue of the server 1 delivering to the client 3 various prompts to be delivered along with the media content and requiring user input. Playback of the media content may be paused or stopped until such prompts are acted upon by the user. Thus, for example, the user may be required to press a certain key or answer a question or so on in response to the prompt before playback will continue.

Validated viewing concerns 83 controlling and monitoring the delivery of the media content in such a way that it is known that at least a predetermined portion of the media content has been properly and completely played back at the client device. Validated viewing 83 is of primary interest at the current time and this will be described in greater detail below.

User comprehension 84 may be controlled and monitored as part of the present techniques on the basis of, for example, issuing questions to the user and recording and/or assessing those answers to test user comprehension. User comprehension can also provide further confirmation of successful playback of the content—i.e. if the questions are answered it indicates that the content has played.

Each of these elements can be useful on its own.

Together these elements of monitoring and controlling user presence, user attention, validated viewing and user comprehension give a powerful system for having knowledge that particular media content has been properly and completely consumed by an identified user.

FIG. 5 is a flow chart schematically showing a process used as part of the validating viewing functionality of the present techniques.

Whilst as is clear from above, the present techniques may be used in respect of different types of media content, perhaps the most common type of media content, which will be delivered and monitored using the current techniques, is video content. Furthermore, whilst it is not essential when making use of the present techniques that the content is streamed (rather than delivered in advance), this again is the most common and preferable scenario. Thus in the description which follows, we consider situations where the media content is video content and this is streamed from the server 1 to the respective client device 3.

Returning now to the process shown in FIG. 5, in step ST1 the server 1 streams the video content to the client 3. In step ST2 the client 3 plays the stream. In step ST3, under the control of the control module 18, the client 3 sends back to the server 1 a beacon signal including various pieces of data. This beacon signal includes details of any playback control commands which have been used at the client device (such as play, pause, stop, fast forward and so on), a data item indicating the amount of content buffered at the device at that point in time, and timing data items. These timing data items comprise a time code, which indicates the portion of the video being played at the client device at the time of generation of the beacon signal, and a time stamp generated with reference to the real time clock 36 of the client, which represents the time indicated by the real time clock when that point of the video content was being played by the client device 3. This time stamp will also represent the time at which the beacon signal is generated by implication.

Note that in alternatives the beacon signals may comprise the timing data items without the buffer data item and/or the details of the playback control commands.

In a further alternative if and when a control command is actioned by the client device, an ACK signal may be sent from the client device 3 to the server 1 including a respective time code and time stamp for that point in time. This can give a more accurate indication of when the command was actioned.

In step ST4 the time of receipt of the beacon signal at the server 1 is determined and logged.

Then in step ST5 the control module 38 is used to correlate the time information in the beacon signal with the time of receipt of the beacon signal at the server 1. This allows determinations to be made as to whether the video content is being completely and properly played back at the client device 3 and/or whether there is any tampering with the system.

In step ST6 the amount of content data transferred by the stream to the client is determined. In step ST7 the amount of content stream transferred to the client is compared to the amount which has been played (which can be determined from the time code included in the beacon signal) plus the amount stored in the buffer at the client (which again is determined from the buffer information included in the beacon signal).

In step ST8 a determination is made as to the amount of stream which has been viewed and also a determination made of the likelihood of an attempt having been made to fool the system. Thus, for example, a determination can be made as to whether it is likely that a user has paused the content and then fast forwarded it rather than watching it through properly.

In step ST9 a determination is made as to the playback quality. To put this another way, a quality of service determination is made. This will provide an indication of whether the video has been provided in a clean way for consumption by the user of the client device or whether it has suffered network glitches or other issues leading to stutter and unintelligible media output.

Steps ST1 to ST9 may be repeated multiple times until the complete stream has been output from the server 1 and played by the client 3. Of course it is not necessarily the case that all of the steps ST1 and ST9 are completed in every iteration. Thus, for example, a whole sequence of beacon signals may be sent and received before the later steps such as steps ST5 to ST9 are carried out.

In step ST10, based on the results of the processes in the above steps, a decision will be made by the control module 18 at the server 1 as to whether at least a predetermined portion of the video content has been properly and completely viewed.

Then in step ST11, validation of stream viewed data may be stored.

It should be noted that if the validated viewing aspects of the system are used together with other aspects such as user presence, user attention and user comprehension (mentioned above in respect to FIG. 4), then details of the results of these processes may also be stored together with the validated viewing data to provide a data package which can further evidence proper and complete consumption of the video content.

It will also be appreciated that there may be variations in the exact order in which steps of the type described above, in relation to FIG. 5, are carried out and the frequency with which they are carried out.

Generally it is desirable that the client device 3 sends beacon signals at regular intervals during the streaming of the content.

These intervals can be chosen such that it becomes impractical for a user to attempt to fool the system by, for example, pausing and then fast forwarding. At some stage the effort and time involved in carrying out such steps will equal or exceed the time needed just to watch the video. As an example, the system may be arranged to send a beacon signal every 10 seconds.

Particularly where content is streamed to the client device 3, it is preferable if at least an initial indication of a problem with the playback can be indicated in real time. This might indicate a problem with the network transmission or client device 3 or some interference by the user.

Thus preferably the control module 18 at the server 1 is arranged to determine the difference between the real time clocks of the client and server 36,16 and compare the time at which each beacon signal is received with the time at which it was sent. If a difference between these times exceeds a certain threshold, this may be used to indicate that the beacon signal is anomalous and can be used to raise an appropriate alarm.

The fact that each beacon signal includes a pair of timing data items relating to the time code of the video being played and a time stamp for the internal real time clock 36 of the client 3 means that a determination can be made as to whether the playback of the video has remained synchronised with the real time clock of the client. This gives an indication that the video has not stopped or paused. Further because any playback control signals used at the client device are relayed to the server 1 (in the beacon signal or alternatively via an ACK signal or set of handshake signals), it can be determined whether there has been any such pausing and subsequent fast forwarding of the video.

By correlating the timing information in each beacon signal with its time of arrival at the server, further confidence can be obtained that the video content has been properly and completely played back.

The server control module 18 is arranged to measure the intervals in time between receipt of successive beacon signals and compare these with the intervals between the time stamps included in the beacon signals, as well as optionally the intervals between the video time codes included in the beacon signals. Further these intervals can be averaged over time to negate the effects of variations in network latency. Once this is taken into account, the intervals should match or at least correlate. Again decisions can be made by the software based on whether the intervals match to within a predetermined tolerance to give an indication of whether the video content has been completely and properly played back.

In general terms correlating the three clocks (the client and server real time clocks plus the video time code) makes it possible to detect any playback irregularities. Typically these will be due to computer or network glitches. Such correlation also makes it hard to cheat the system without spending the same amount of time as would be required to watch the video.

By measuring the amount of video stream data transferred from the server 1 to the client 3 during the playback it makes it even less likely that any automated systems would be able to cheat the system, at least without downloading the data each time. That is to say any server “farm” setup to give false views would have to suffer the bandwidth penalty of downloading the data for each view.

In a development of the system, the client device 3 can be arranged, in response to an instruction from the server 1, under the control of the control module 38, to capture a snapshot image from the device camera 34 and at the same time acquire a screen grab from the video playing at the client device 3 at that time. The resulting image pair can then be forwarded to the server 1. This provides a further indication that the video was successfully playing and also being consumed by the user. If playback was not succeeding due to a missing video codec or other component, the screen grab would fail or be blank.

There now follows some more specific details of the processes and messages sent between the server 1 and the client 3 in a specific implementation of the system.

In the specific implementation of the system there are three or more asynchronous bi-directional electronic network connections per client 3: one short lived connection to deliver a content page (for example an initial webpage), a second persistent connection to allow on-going messaging between the client 3 and server 1, and a third connection to allow delivery of the content itself. The connection to allow delivery of the content itself is generally conventional and thus not described further here. The other two connections will be described further below, with reference to the message sequence chart shown in FIGS. 6, 7 and 8.

A primary identifier (client_id) is generated by the server together with secondary verification identifiers to ensure secure operation of the system. Client_id is used to track activity across the three connections from the same source.

All messages from the client 3 contain a time stamp representing the date and time held by the real time clock 36 at the client. During playback the beacon messages (PLAYBACK_STATUS), are despatched from the client 3 to the server 1 containing both the time code from the video being replayed and the client time stamp as discussed above.

A challenge at the server is to perform continuous anomaly detection in real time as the video plays, thereby alleviating the need to retrospectively analyse the timing data. This approach brings two benefits: it allows alerts to be generated at the time the anomaly is detected to allow investigation or warning to the user or a supervisor and it simplifies the execution thread at the server 1. To facilitate this a messaging interchange between the server 1 and client 3, which is separate from the messaging sequences to control playback, is used to determine the typical end to end network latency. Latency includes the delays attributed to processing the high level messages in the client and server control modules 18 and 38. From this, it is possible to estimate, to a reasonable degree of accuracy, the difference between the real time clocks of the client 3 and server 1. It is then possible to determine at the time each beacon signal is received, whether the beacon itself is anomalous (e.g. it was delayed excessively in the network, the video playback has suffered a glitch, or an attempt is being made to fool the system).

FIG. 6 schematically shows an overview of the process of messaging between the client 3 and server 1 during operation of the specific implementation. In step ST601 the client initiates a connection with the server 1. At this time, in step ST602, the server generates parameters to handle the new connection and logs appropriate details. In step ST603 a content page, including an embedded video, is delivered to the client device 3.

In step ST604 an initial sequence of messages between the client 3 and server 1 take place to establish the communications protocol. After this at step ST605 the server 1 has measured a good estimate of the communication latency between the control modules 18 and 38 at the server and client.

At this stage, at step ST606, the user clicks play to start the video or alternatively the video starts automatically. Following this, in step ST607, a series of hand shaking messages are exchanged between the client device 3 and the server 1. Following this process, at step ST608, the server 1 has a good approximation of the time difference between the client and server real time clocks 36,16.

Then playback is in process at the client 3 as indicated at step ST609. During playback, in Step ST610, beacon signals (PLAYBACK_STATUS) are sent from the client device 3 to the server 1. These are repeated every n seconds until playback is finished in step ST611. Then in step ST612 the server analyses all of the data gathered for anomalies to enable a decision to be made as to whether the video has been completely and properly played back at the client device.

FIG. 7 shows in more detail the initial stages of the process in FIG. 6 (steps ST601 to ST604) and in particular the process of establishing the communication protocol in step ST604. In step ST701 as a result of the client device accessing a content page including an embedded video in step ST601 of FIG. 6, a GET message is issued by the client device 3 in step ST701 of FIG. 7. In response to this an OKAY message including the video content page and a client_id is returned to the client device in step ST702. Then in step ST703 the process of beginning to set up the protocol starts automatically as the page delivered in step ST702 is loaded. In step ST704 the client device issues a GET command to initiate the process. In step ST705 an OKAY message is returned to establish a persistent connection which remains open allowing the server 1 to push messages out to the client 3 in real time. A COMET_OPEN message is sent in step ST707 as a result of which the client will open the connection and in step ST708 the client 3 returns an OPEN_ACKNOWLEDGE message including the client_id back to the server. In response to this, in step ST709, the server measures and stores a response latency between the OPEN and OPEN_ACKNOWLEDGE signals and maintains a moving average response latency for each acknowledged message pair. The server then issues a further message in step ST709 as a HELLO request requiring a HELLO_RESPONSE in step ST710 by the client 3 which can then be used in step ST713 to augment the moving average response latency. As indicated in step ST714 this exchange of messages is continued in parallel with other functions to allow ongoing updating of the moving average response latency held at the server 1.

As explained above, knowing the average response latency is useful as it enables a determination of the difference between the real time clock at the server and the client. This allows certain anomalies to be detected that could indicate attempts to fool the system.

Once the initiation process is complete then in step ST715, corresponding to step ST606 in FIG. 6, video playback can commence.

More detail of the messages transferred between the client 3 and server 1 during the playback process will now be explained with reference to FIG. 8.

In step ST801, corresponding with steps ST606 in FIG. 6 and ST715 in FIG. 7, a user clicks play or a video is set to start automatically. This causes a PLAY_REQUEST message including a client_id and a client_timestamp to be sent to the server 1. In response to this, a PLAY_RESPONSE(OK) message is sent back to the client in step ST803, causing a PLAY_RESPONSE_ACKNOWLEDGE signal 804 to be sent back to the server 1 and allowing playback to progress as indicated in step ST805.

Then in step ST806 the server 1 determines whether the time between the PLAY_REQUEST and RESPONSE is within a predetermined number of standard deviations of the moving average response latency. If so then the server may calculate a good approximation between the internal clocks of the server and client (clock_delta) based on a client time stamp in the PLAY_RESPONSE_ACKNOWLEDGE signal and the time of receipt of that signal at the server.

On the other hand, if it is determined that the latency between PLAY_REQUEST and RESPONSE is outside of the predetermined number of standard deviations of the moving average latency then a PLAYBACK_STATUS_REQUEST message is sent in step ST808 to the client, causing a response in step ST809 of a PLAYBACK_STATUS_RESPONSE message. This includes the client_id, client_timestamp, video timecode and playback_status (and is a beacon signal). At this point, in step ST810, the server 1 determines a statistically significant approximation of the difference in the internal clocks of the server and the client i.e. clock_delta. These above processes 806-810 can be repeated as necessary in the background.

Meanwhile, as indicated at step ST811, every n seconds the client sends a playback_status message (beacon signal) to the server 1. Each playback_status message includes the client_id, client_timestamp, video timecode and playback_status.

If a user uses a playback control function such as pause, stop or rewind, as indicated in step ST812, then as indicated in step ST813, in response to this, the client 3 sends a PLAYBACK_STATUS_CHANGE message to the server 1. The PLAYBACK_STATUS_CHANGE message includes the client ID, an indication of the playback control demand activated by the user, the client timestamp and the video timecode (again this is a beacon signal).

If, as in this case, pause is activated then playback is paused as indicated in step ST814. It will be noted that the fact that playback has paused has been reported to the server 1 due to the content of the PLAYBACK_STATUS_CHANGE message. Then, if as in step ST815, the user clicks resume then another PLAYBACK_STATUS_CHANGE message is sent to the server. Again including the client ID, the indication of the change in playback status, the client timestamp and the video timecode. Playback will then continue as indicated in step ST817 with the client sending PLAYBACK_STATUS messages i.e. beacons signals every n seconds. This continues until playback is finished at step ST819 after which in step ST820 the server can analyse all of the gathered data for evidence of contiguous playback and any time anomalies.

As will be seen from above, the beacon signals sent may have two different origins. There may be regular beacon signals issued at predetermined intervals and ad-hoc beacon signals prompted by a server request or a change in state at the client 3.

Although not shown in these sequences, as mentioned above, the system in this specific implementation may also carry out real time anomaly detection based on the time of receipt of, for example, a PLAYBACK_STATUS message (beacon signal) and its time stamp.

Further it will be appreciated that the exact number of and sequence of messages shown in FIGS. 6 to 8 may be varied in other implementations. Thus as an example sometimes a single message may serve two functions—eg a message carrying data may be used as an implicit acknowledgement of receipt of an earlier message.

Note that the current techniques allow an assessment to be made as to whether media content has completely and properly played back on one of any number of different client devices without having to have had to proof test playback on each and every available device/software combination or provide a complete and encapsulated dedicated player for each and every available device/software combination.

1. A method of monitoring media playback in a system where a server is arranged under the control of software to output media content over a network to a client device, the method comprising the steps of:
outputting media content from a server over a network to a client device,
receiving at the server from the client device, a plurality of beacon signals, each beacon signal comprising at least one pair of timing data items, a first data item in the pair representing a point in time in the media content and a second data item in the pair representing a time indicated by a real time clock of the client device at which time the part of media content corresponding to said point in time was being played by the client device, and
at least one of processing or storing the beacon signals at the server so as to monitor the playback of the media content by the client device.

2. A method of monitoring media playback according to claim 1 in which said point in time in the media content is represented by a time code.

3. A method of monitoring media playback according to claim 1 in which the media content is streamed media content.

4. A method of monitoring media playback according to claim 3 in which the beacon signals are received spaced in time from one another and the beacon signals are received whilst the media content is being streamed to the client device.

5. A method of monitoring media playback according to claim 1 comprising the further step of logging, at the server, a time of receipt of each beacon signal at the server, with reference to a real time clock at the server.

6. A method of monitoring media playback according to claim 1, the method comprising the further step, at the server, of deciding in dependence on the received beacon signals whether a predetermined portion of the media content has been properly and completely played by the client device.

7. A method of monitoring media playback according to claim 6 in which the deciding step comprises the step of, at the server, comparing at least two pairs of received data items.

8. A method of monitoring media playback according to claim 7 in which the deciding step comprises a first interval comparison step, comprising:
using a first pair of data items and a second pair of data items,
determining as a content time interval, the time interval between the point in time in the media content indicated by the first pair of data items and the point in time in the media content indicated by the second pair of data items,
determining as a playback time interval, the time interval between the time indicated by a real time clock of the client device indicated by the first pair of data items and the time indicated by a real time clock of the client device indicated by the second pair of data items, and
comparing the content and playback time intervals.

9. A method of monitoring media playback according to claim 5, further comprising, at the server, deciding in dependence on the received beacon signals whether a predetermined portion of the media content has been properly and completely played by the client device and wherein the deciding step comprises correlating at least one of the timing data items in at least one beacon signal with the time of receipt of the respective beacon signal.

10. A method of monitoring media playback according to claim 5, further comprising, at the server, deciding in dependence on the received beacon signals whether a predetermined portion of the media content has been properly and completely played by the client device and wherein the deciding step comprises a second interval comparison step, comprising:
using at least one timing data item of a first beacon signal and at least one timing data item of a second beacon signal,
using a time of receipt of the first and second beacon signals,
determining as a playback time interval, the time interval between the time indicated by a real time clock of the client device indicated by the first beacon signal and the time indicated by a real time clock of the client device indicated by the second beacon signal,
determining as a reception time interval, the time interval between the time of receipt of the first and second beacon signals and
comparing the playback and reception time intervals.

11. A method of monitoring media playback according to claim 8 in which the deciding step comprises calculating a time averaged value for at least one of the types of intervals and using the time averaged value in comparison to at least one of the other intervals or a time averaged value thereof.

12. A method of monitoring media playback according to claim 1 in which each beacon signal further comprises a media playback control data item indicating of operation at least one playback control function at the client device.

13. A method of monitoring media playback according to claim 1 in which the method comprises the further step of measuring at the server the amount of media content data output to the client.

14. A method of monitoring media playback according to claim 1 in which each beacon signal further comprises a buffer content data item indicating the amount of media content data buffered at the client device at the time of generation of the beacon signal.

15. A method of monitoring media playback according to claim 6 further comprising measuring at the server the amount of media content data output to the client and wherein each beacon signal further comprises a buffer content data item indicating the amount of media content data buffered at the client device at the time of generation of the beacon signal, and the deciding step comprises:
determining the amount of the media content played by the client device at the time of generation of a beacon signal in dependence on the first timing data item of the beacon signal which represents a point in time in the media content; and
comparing the measured amount of media content data output to the client to the sum of the determined amount of the media content played and the amount of media content data buffered at the client device as indicated by the buffer content data item in the beacon signal.

16. A method of monitoring media playback according to claim 6 in which the deciding step comprises:
determining whether the time at which a respective one of the beacon signals is received at the server is anomalous based on a comparison of:
i) the second timing data item of the respective beacon signal representing a time indicated by a real time clock of the client device,
ii) the time of receipt of the respective beacon signal at the server, and
iii) a determined difference between the real time clock of the client device and the real time clock at the server.

17. A method of monitoring media playback according to claim 16 in which the determining step is carried out in real time.

18. A method of monitoring media playback according to claim 6 in which the deciding step comprises the step of monitoring the network quality of service associated with playback of the media content at the client device on the basis of at least one of: the content of the received beacon signals, the time of receipt of the received beacon signals, or the determined difference between the real time clock of the client device and a real time clock at the server.

19. A media playback server for outputting media content over a network to a client device and monitoring playback of the media content, the server being arranged under the control of software to:
output media content from the server over a network to a client device, receive from the client device, a plurality of beacon signals, each beacon signal comprising at least one pair of timing data items, a first data item in the pair representing a point in time in the media content and a second data item in the pair representing a time indicated by a real time clock of the client device at which time the part of media content corresponding to said point in time was being played by the client device, and
at least one of process or store the beacon signals at the server so as to monitor the playback of the media content by the client device.

20. A method for monitoring media playback in a system where a client device is arranged under the control of software to receive media content over a network from a server, the method comprising the steps of:
receiving media content from a server over a network at a client device,
playing back the media content to a user, and
sending from the client device to the server, a plurality of beacon signals, each beacon signal comprising at least one pair of timing data items, a first data item in the pair representing a point in time in the media content and a second data item in the pair representing a time indicated by a real time clock of the client device at which time the part of media content corresponding to said point in time was being played by the client device, thus allowing monitoring by the server of playback of the media content at the client device.

21. A method of monitoring media playback according to claim 20 in which the beacon signals are sent spaced in time from one another and the beacon signals are sent whilst the media content is being streamed to the client device.

22. A method of monitoring media playback according to claim 20 in which each beacon signal further comprises at least one of:
a media playback control data item indicating operation of at least one playback control function at the client device, or
a buffer content data item indicating the amount of media content data buffered at the client device at the time of generation of the beacon signal.

23. A method of monitoring media playback according to claim 20 in which the client device is arranged to acquire, at substantially the same time, a snapshot from a camera of the client device and a screen grab from the content playing back at the client device, and sending the snapshot and screen grab to the server.

24. A client device for use in monitored playback of media content, the client device being arranged under the control of software to:
receive media content over a network from a server,
playback the media content to a user, and
send from the client device to the server, a plurality of beacon signals, each beacon signal comprising at least one pair of timing data items, a first data item in the pair representing a point in time in the media content and a second data item in the pair representing a time indicated by a real time clock of the client device at which time the part of media content corresponding to said point in time was being played by the client device, thus allowing monitoring by the server of playback of the media content at the client device.

25-26. (canceled)

27. A video playback system comprising a server connected to a client device over a network,
the server being arranged under the control of software to output a video stream to the client device and monitor the playback of the video stream by the client device, wherein
the client device comprises a real time clock and is arranged under the control of software to send to the server a plurality of beacon signals, each beacon signal comprising at least one pair of timing data items, a first data item in the pair representing a time code from the video stream and a second data item in the pair representing a time indicated by the client device real time clock at which the part of video stream corresponding to said time code was being played by the client device, and
the server is arranged under the control of software to at least one of process and store the beacon signals so as to monitor the playback of the video content by the client device.

28. (canceled)

29. A computer program product comprising a machine readable data carrier on which is carried a computer program which when loaded and run on a computer causes the computer to carry out a method according to claim 1.
